(19) United States
(12) Patent Application Publication
(10) Pub. No.: US 2004/0190439 A1
(43) Pub. Date: Sep. 30, 2004

(54) Method and circuit arrangement for the secure transmission in digital transmission systems

(76) Inventors: Guenther Komp, Stockstadt (DE); Rolf Matzner, Muenchen (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/168,360

(22) PCT Filed: Dec. 9, 2000
(86) PCT No.: PCT/EP00/12463

(30) Foreign Application Priority Data
Dec. 22, 1999 (DE) 199 61 969.7
Mar. 3, 2000 (DE) 100 14 463.2

(51) Int. Cl. H04J 11/00

(52) U.S. Cl. 370/208

(57) ABSTRACT

The invention relates to a method for securely transmitting data by hiding in point-to-point and point-to-multi-point digital transmission systems. The data stream (DS) on the transmitter side is supplied to a modulation unit (MOD). The modulation and coding parameters (MP) of the modulation process (MV) and of said modulation unit (MOD) can be changed in time. The modulation parameters (MP) are transmitted to a demodulator (DEM) by means of a secure channel (SK). The electric transmission signal (ES) is situated at the output of the modulation unit (MOD). Said signal is transmitted by means of a channel (K). The demodulator (DEM) that knows the hiding sequence regenerates the original signal and supplies the receiving data stream (DE) at the output.

The present invention relates to a method for securing the transmission channel in point-to-point and point-to-multipoint digital transmission systems according to the definition of the species in Patent claim 1.

A previously known method of the so-called “coded modulation” is described by G. Ungerboeck under the title “Channel coding with multilevel/phase signals” in IEEE Trans. on Information Theory, vol. IT-28, no. 1, pp. 55-67, January 1982.

A further known method is also described by G. Ungerbroeck under the title “Trellis-coded modulation with redundant signals set” in IEEE Comm. Mag., vol. 25, no. 2, pp. 5-21, Febuary 1987.

Baseband transmission methods are described, for example, in the ISDN (ETSI TS080 r3a) and the HDSL (ETSI TS 101 135 V1.4.1) standards. These methods include a plurality of steps; a method of that kind is described, in particular, on pages 21-22 of the HDSL standard.

As clearly follows from the description of the known methods in the cited publications, these methods are limited in their range of application. Besides, the technical outlay would be high very particularly in the Mbit/s range.

Therefore, the object of the present invention is to provide a method for securing the transmission channel in point-to-point and point-to-multipoint digital transmission systems which is based on the hiding of the data stream, makes the use of additional hardware superfluous especially in the case of bit rates in the Mbit/s range, and which, moreover, is able to be implemented in software, in particular, in DMT methods in ADSL systems, and to provide a circuit arrangement for carrying out the method.

The means for attaining the object of the invention consists in the feature of Patent claim 1 for the method.

Further design approaches or embodiments of the present invention are characterized in Patent claims 1 through 10.

The circuit arrangement for carrying out the method is characterized in Patent claim 11.

The new method for securing the transmission channel in point-to-point and point-to-multipoint digital transmission systems consists primarily in that it is not based on encrypting the data stream but on hiding the transmission signal. Therefore, unlike common practice in the related art, no encryption of the binary level is carried out.

A further important advantage of the design approach according to the present invention is that it is suitable for all methods of multicarrier, single-carrier, and carrierless amplitude modulation/pulse modulation, coded modulation, and baseband transmission. Hiding and unhiding has the advantage that, especially in the case of bit rates in the Mbit/s range, the use of special additional hardware is superfluous, and that, in the case of DMT methods in ADSL systems, it is able to be implemented in software, which was not the case in the methods that have heretofore become known.

Further advantages, features and possible uses of the present invention, in particular, of the hiding and unhiding, follow from the following description in conjunction with the exemplary embodiments shown in the drawing.

In the following, the present invention will be explained in greater detail in the light of exemplary embodiments shown in the drawing. The terms and associated reference symbols specified in the list of reference symbols given at the back are used in the description, in the patent claims, in the abstract, and in the drawing.

### In the drawing,

FIG. 1 shows a schematic flow chart;

FIG. 2 is a detailed functional program for single-carrier transmission methods; and

FIG. 3 shows an example for hiding in accordance with the present method.

The present method for securing the transmission channel, in particular, in point-to-point and point-to-multipoint digital transmission systems by hiding the data transmission is based on that the data encryption is not carried out on the binary level but in the modulation process by changing the modulation parameters over time which are transmitted to a demodulator via a secure channel. In this context, the secure channel is externally implemented by a separate transmission path or integrated in the transmission path and protected using cryptographic methods.

In the case of the implementation for multicarrier transmission methods, so-called “multitone methods”, in which the information is transported on several channels which are modulated using quadrature amplitude modulation QAM, both the assignment of frame bits to the individual channels and the assignment of information bits to the modulation symbols per channel (so-called “mapping”) and, moreover, the assignment of the respective modulation alphabet are varied over time for each individual carrier.

For the multicarrier transmission methods as are defined in the current ADSL systems according to ANSI standard T1E1.4/98-007 and ETSI DTS/TM-06006, the assignment of ADSL frame bits to the individual channels (so-called “tone ordering”), the assignment of the information bits to the modulation symbols per channel (so-called “mapping”) and also the assignment of the modulation alphabet are carried out variably over time for each individual carrier.

For the implementation for single-carrier transmission methods using quadrature amplitude modulation QAM, as they are used in line-of-sight radio relay systems and in the broadband cable, the assignment of the transmitted bits to the modulation symbols is carried out variably over time.

For the implementation for carrierless amplitude/phase modulation methods (so-called “carrierless AM/PM(CAP) methods”), as are used as a special case in the transmission of HDSL systems, the assignment of the transmitted bits to the modulation symbols is also carried out variably over time.

For baseband transmission methods, for example, according to the ISDN-(ETSI TS080 r3a) and HDSL (ETSI TS 101 135 V1.4.1) standards, which include more than two steps, the assignment of the transmitted bits to the signal steps is also carried out variably over time. This is also true for the so-called “coded modulations”, the assignment of the information bits to the modulation symbols per channel (so-called “mapping”), the code parameters such as the generator polynomials in block codes and convolutional codes also being varied over time.

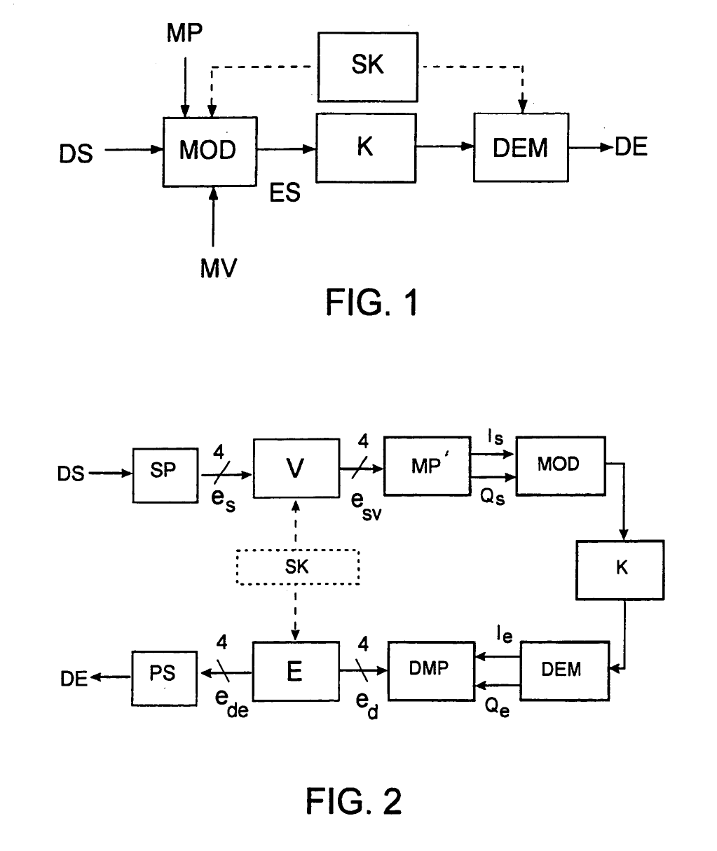

In FIG. 1, the basic mode of operation is shown by way of a schematic flow chart. The method according to the present invention will now be explained, first of all, in principle by way of this Figure.

Initially, the data stream DS on the transmit side is fed to a modulation unit MOD whose modulation parameters MP of modulation process MV are variable over time. Modulation parameters MP are transmitted to a demodulator DEM via a secure channel SK. At the output of modulation unit MOD, an electrical transmission signal ES is present which is transmitted via channel K. Demodulator DEM regenerates a received signal of a received data stream DE with the aid of the knowledge time-dependent modulation parameters MP.

A further exemplary embodiment for a single-carrier transmission method 16-QAM is shown in principle in FIG. 2 and will be explained hereinafter.

Serial binary data stream DS is applied to the input of a serial-to-parallel converter SP which performs a conversion to 4-bit words. The output of this converter is connected to a hiding unit V which induces a time-variable assignment of an input word to the output word. A modulation symbol assignment unit MP′, or also “mapping unit”, then establishes a unique assignment to the channel symbol to be transmitted which is marked by values Is and Qs. Modulator MOD generates the electric HF signal which is transmitted via channel K.

In a demodulator DEM at the receive side, the HF signal is converted to a two-dimensional baseband signal having the components Ie and Qe. A demapping unit DMP generates a binary 4-bit word e_{d}. A subsequent unhiding unit E generates, at its output, binary 4-bit word e_{de} which is transmitted to a parallel-to-serial converter PS and is available at the output thereof as received data stream DE. The hiding sequence is transmitted between hiding unit V and unhiding unit E via a secure channel SK which can be implemented externally or also be integrated in the main channel.

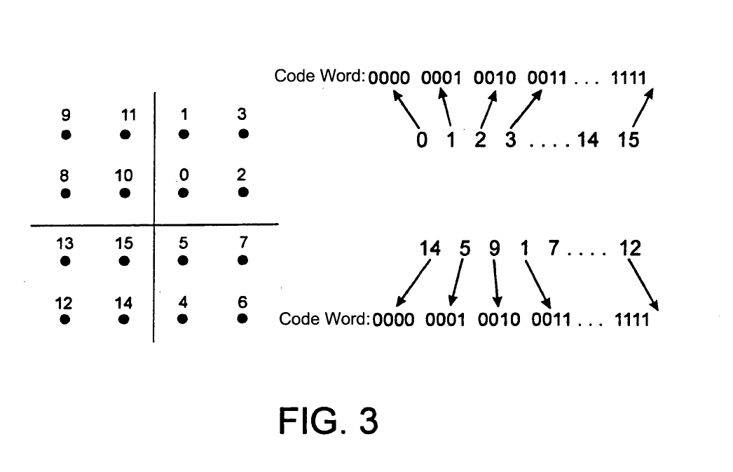

FIG. 3 schematically represents the hiding of code words as underlies the present method. The hiding effect is shown with the example of the 16-QAM signal state diagram. The points of the diagram correspond to the possible pairs of values Iₛ and Qₛ at the input of modulator MOD in FIG. 2. Since mapping block MP uniquely maps input side binary vector eₛᵥ to a point of the constellation diagram and, equally, hiding block (V) uniquely maps eₛ to eₛᵥ, the effect of hiding unit V can be understood as a unique change in assignment of the points of the signal constellation to the sixteen different values of binary vector eₛ. This change in assignment is indicated by the arrows in FIG. 3. Unhiding unit E performs this change in assignment in reverse. Provided that no transmission error has occurred, binary word e_{de} at the output of unhiding unit E is identical to binary word eₛ at the input of hiding unit V.

### List of Reference Symbols

DE received data stream

DEM demodulator

DMP demapping unit

DS data stream

e_{d}, dₑ word (binary)

eₛ, eₛᵥ word (binary)

E unhiding unit

ES electrical transmission signal

Iₛ, Qₛ components of the two-dimensional baseband signal (at the modulator input)

Iₑ, Qₑ components of the two-dimensional baseband signal (at the demodulator output)

MOD modulator

MP modulation parameters

MP′ mapping unit or modulation symbol assignment unit

MV modulation process

Qₛ channel symbol

K channel

SP/PS serial-to-parallel or parallel-to-serial converter

SK secure channel

V hiding unit

What is claimed is:

1. A method for securely transmitting data of a transmission channel in point-to-point and point-to-multipoint digital transmission systems,
wherein an electrical transmission signal (ES) of a data stream (DS) is hidden in the modulation process by changing modulation parameters (MP) over time; and
the modulation parameters (MP) are transmitted to a demodulator (DEM) via a secure channel (SK).

2. The method as recited in the preamble of Patent claim 1,
wherein a data stream (DS) on the transmit side is fed to a modulator (MOD);
modulation parameters (MP) of a respective modulation process (MV) are variable over time;
the modulation parameters (MP) are transmitted to a demodulator (DEM) via a secure channel (SK);
at the output of the modulator (MOD), an electrical transmission signal (ES) is present which is transmitted via a channel (K); and
the demodulator (DEM) regenerates the received signal (ES) with the aid of time-dependent modulation parameters (MP).

3. The method as recited in Patent claim 1 or 2,
wherein the secure channel (SK) is implemented externally by a separate transmission path.

4. The method as recited in one of the Patent claims 1 or 2,
wherein the secure channel (SK) is integrated in the transmission channel (K) and protected using cryptographic methods or methods for securely transmitting the data.

5. The method as recited in one of Patent claims 1 or 2,
wherein in multicarrier transmission methods, in particular, so-called “multitone methods”, in which the information is transported on several QAM-modulated channels, through assignment of the frame bits to the individual channels, the assignment of the information bits to the modulation symbols per channel, the so-called “mapping”, and the assignment of the modulation alphabet are varied over time for each individual carrier.

6. The method as recited in one of the Patent claims 1 through 5,
wherein in ADSL systems according to ANSI standard T1E1.4/98-007 and ETSI DTS/TM-06006, the assignment of ADSL frame bits occurs to the individual channels,
the assignment of the information bits to the modulation symbols per channel, and
the assignment of the modulation alphabet are varied over time for each individual carrier.

7. The method as recited in one of the Patent claims 1 through 4,
wherein for the implementation in a single-carrier transmission method using quadrature amplitude modulation (QAM), the assignment of the transmitted bits to the modulation symbols is varied over time.

8. The method as recited in Patent claims 1 through 4,
wherein for the implementation for carrierless amplitude/phase modulation methods (carrierless AM/PM(CAP) methods) and, as a special case, for the transmission in HDSL systems, the assignment of the transmitted bits to the modulation symbols is varied over time.

9. The method as recited in one of the Patent claims 1 through 4,
wherein for the implementation for baseband transmission methods including more than two steps, the assignment of the transmitted bits to the signal steps is varied over time.

10. The method as recited in one of the Patent claims 1 through 4,
wherein in the case of the implementation for coded modulation methods, the assignment of the information bits to the modulation symbols per channel, and the code parameters, in particular, generator polynomials in block codes and convolutional codes, are varied over time.

11. A circuit arrangement for carrying out the method according to one of the Patent claims 1 or 2 or 5.
